(19) United States
(12) Patent Application Publication
(10) Pub. No.: US 2005/0199090 A1
(43) Pub. Date: Sep. 15, 2005

(54) Handlebar clamp

(75) Inventor: Andrew Charles Renshaw, Macclesfield (GB)

Correspondence Address: OLIFF & BERRIDGE, PLC, P.O. BOX 19928, ALEXANDRIA, VA, 22320, US

(73) Assignee: RENTHAL LIMITED, Stockport (GB)

(21) Appl. No.: 11/070,305

(22) Filed: Mar. 3, 2005

(30) Foreign Application Priority Data
Mar. 12, 2004 (GB) 0405535.6

(51) Int. Cl. B62K 21/12

(52) U.S. Cl. 74/551.1

(57) ABSTRACT

In respect of a clamp arrangement for the centre of a handlebar, which may comprise a pair of spaced clamps or a single clamp, or for securing a cross brace to a handlebar, the provision of a protective component, such as a nylon sleeve or other polymeric insert, between the or each clamp and the bar at the edge margin (or respective edge margins) of the clamp nearest the end of the bar greatly increases the fatigue life of the bar. The protective component is seated in a recess and only extends part way in from the edge of the clamp, so that there is still sufficient direct clamping between the material of the clamp or clamps and the bar to prevent any rotation of the bar.

### TECHNICAL FIELD OF THE INVENTION

This invention concerns a clamp for a handlebar. It is particularly suitable for a motorcycle handlebar, but could also be applied to a handlebar for a bicycle, a jet ski, a scooter, a quad bike or any other vehicle.

Handlebars for many such vehicles are typically of tubular form. Traditionally they were made of steel, but nowadays aluminium or an alloy thereof is the preferred material. The invention is applicable to a clamp for any handlebar, of any configuration, whether of metal, as is conventional, or of other material, such as carbon fibre.

### BACKGROUND OF THE INVENTION

Handlebars are typically clamped at a central location, by a single mounting or a pair of spaced mounting means. In respect of motorcycle handlebars, each mounting usually comprises an upper and a lower clamp element formed with corresponding part-cylindrical clamping surfaces and fastened together, encircling and clamping a handlebar there between, by two or more bolts. In respect of bicycle handlebars, the mounting may comprise a pair of clamp elements as just mentioned, but also quite common is a single C-shaped clamp which encircles the bar and has opposing end regions which are bolted together.

In a conventional handlebar mounting or clamp there is metal to metal contact between the clamping surfaces and the handlebar. The clamping bolts need to be very tight so that, in use, the handlebar does not rotate in the clamp. This imposes a heavy compressive stress at the surface of the handlebar which must deflect to some extent to resist this. On disassembly, permanent compression is occasionally visible showing that the handlebar material has been compressed into the plastic range.

In the extremely short distance between the area of compression under the clamp and the uncompressed free surface of the handlebar, tensile stresses exist. This is due to the lengthening of the surface that must take place there between the deflected and undeflected areas. Crucially, at an end of the clamp from where the unsupported bar extends, this is also the point of maximum bending moment, and therefore maximum stress, when the handlebar is in use.

In use, there is also a certain amount of fretting between the handlebar and the clamp caused by the deflection of the handlebar under load. Again, this occurs at one end or respective ends of the clamp, between the deflected and undeflected portions of the handlebar and at the point of maximum stress. Surface damage of this sort can be exacerbated by a common practice of motorcycle riders whereby, in order to achieve an optimal riding position, they rotate the handlebar by force in semi-tightened clamps.

All of these factors, namely the compressive stress of clamping, the tensile stress caused by surface deformation, fretting damage and in use deflection under load, contribute to any fatigue failure of a handlebar. They all act at the same location, where the unsupported handlebar emerges from the clamp, and that is invariably the location where the bar will break if there is fatigue failure.

Motorcycle handlebars, particularly those used for motocross, trials and enduro competitions, have a characteristic bent configuration comprising a central section leading at each end, via a proximal bend to an intermediate or bent section, which leads, via a respective distal bend to a respective end section including a terminal hand grip region. Many motorcycle handlebars have a cross brace extending between the respective intermediate sections and clamped thereto adjacent the respective distal bends.

The above mentioned factors of stress and fretting damage (except that damage by rider adjustment should not apply) also contribute to any handlebar fatigue failure adjacent a cross brace clamp. Indeed, in respect of braced motorcycle bars, the distal edge of one of the two cross brace clamps is the most common position of bar breakage, whether or not due solely or partially to fatigue failure.

### SUMMARY OF THE INVENTION

According to the present invention it has now been ascertained that a surprisingly large increase in fatigue life of a handlebar clamped in a mounting is obtained when a protective component of a material somewhat softer than the material of the clamp or the handlebar is interposed between the clamping surface of the mounting and the handlebar at the point where the handlebar emerges from the clamp to extend unsupported. However, the protective component, which may be slightly deformable, must not overlie the entire clamping surface. Sufficient direct contact between the mounting and the handlebar must remain to prevent any rotation of the handlebar within its mounting.

The present invention is applicable to the clamp or clamps at a central location of a handlebar and also to clamps for securing a cross brace to a handlebar.

The invention more specifically provides a handlebar clamp comprising mounting means adapted to embrace and clamp a handlebar, said mounting means having first and second ends longitudinally of the bar, a clamping surface facing the bar and a recess formed in the clamping surface and extending from said first end part way towards said second end, and a protective component, of a material softer than that of the clamp and the handlebar, which is seated in that recess so as, in use, to be interposed between the mounting means and the handlebar for only a part of the length of the clamping surface.

The aforesaid clamp may be one of a pair of adjacent centre clamps of a motorcycle or other vehicle handlebar or may be a cross brace clamp of a motorcycle handlebar.

The invention also provides a handlebar clamp comprising mounting means adapted to embrace and clamp a handlebar, said mounting means having first and second ends longitudinally of the bar, a clamping surface facing the bar, a first recess formed in the clamping surface and extending from said first end part way towards said second end, and a second recess formed in the clamping surface and extending from said second end part way towards said first end, a first protective component, of a material softer than that of the clamp and the handlebar, which is seated in said first recess and a second protective component, also of a material softer than that of the clamp and the handlebar, which is seated in said second recess so that, in use, the protective components are interposed between the mounting means and the handlebar for only a part of the length of the clamp with a central region of the clamping surface therebetween.

The aforesaid clamp is intended as a single centre clamp for a handlebar for any type of vehicle.

The provision of a protective component overlying this location on the handlebar previously most vulnerable to fatigue failure, ie adjacent the end of the clamp, prevents any fretting damage at this location, prevents deformation and tensile stress and also substantially reduces compressive stress at this location. Only the in service stress caused by handlebar deflection in use remains.

In most practical embodiments it will be appropriate for the recess in which the protective component is seated to extend fully to the end of the clamping surface of the mounting means, so that said recess is open to said end without any retaining flange or lip at said end. However, in some embodiments the recess may be stepped or tapered in cross section so that it is somewhat shallower at its open end, that is at the end of the clamping surface, compared to at its closed end or inner end. The resulting shallow lip or the taper, whichever is provided, would prevent the protective component moving out from the end of the clamping surface, although a tendency to such movement has not been noted in any tests to date. Any such lip or taper would be very slight given that the maximum depth of the recess may be only 0.5 mm or less.

Testing so far carried out, by imposing a repeated 70 Kg upward and downward load on the end of a straight tube of aluminium alloy of conventional handlebar dimensions held in a clamp in accordance with the invention has shown a surprising increase in life before fatigue failure by over 13 times compared to a conventionally clamped tube. Specifically over 190,000 load cycles were achieved by the tube clamped in accordance with the invention compared to a maximum of 13,950 for a conventionally clamped tube.

The configuration of the protective component is not believed to be important. A substantially cylindrical sleeve is a convenient form for fitting to the clamp, particularly if it is split from end to end for location over the handlebar. More than one such split cylindrical sleeve, arranged in series, longitudinally of the bar, and possibly of different materials or different grades of material, could be provided. Another possibility is that a part cylindrical component or two or more part cylindrical components could be used. Other forms of insert are also possible.

A suitable material for the or each protective component is a polymeric material, such as nylon. However, other plastics materials could be employed.

Such materials may be resilient, but that is not the primary attribute required for this purpose. They merely need to be somewhat softer (less hard, less rigid) than the material of the clamp and of the bar itself.

The protective component probably needs to extend inwards from the end of the clamp surface for 5 mm or more in order to bring about a significant increase in handlebar life as has so far been apparent in tests. Similarly, a thickness of about 0.5 mm or more is probably required for satisfactory effect, although a component thickness of as little as 0.3 mm or less may still be effective.

### BRIEF DESCRIPTION OF DRAWINGS

The invention will be described further, by way of example, with reference to the accompanying drawings in which:

FIG. 1 is a plan view of one half of a conventional motorcycle handlebar fitted with a cross brace;

FIG. 2 is a front view of the same half handlebar as in FIG. 1;

FIG. 3 is a fragmentary perspective exploded view showing a pair of clamps in accordance with the invention and how they would be fitted to a handlebar;

FIG. 4 is a similar fragmentary perspective exploded view showing a single central clamp in accordance with the invention and how it would be fitted to a handlebar; and

FIG. 5 is a perspective exploded view of a cross brace clamp in accordance with the invention.

### DETAILED DESCRIPTION OF ILLUSTRATED EMBODIMENTS

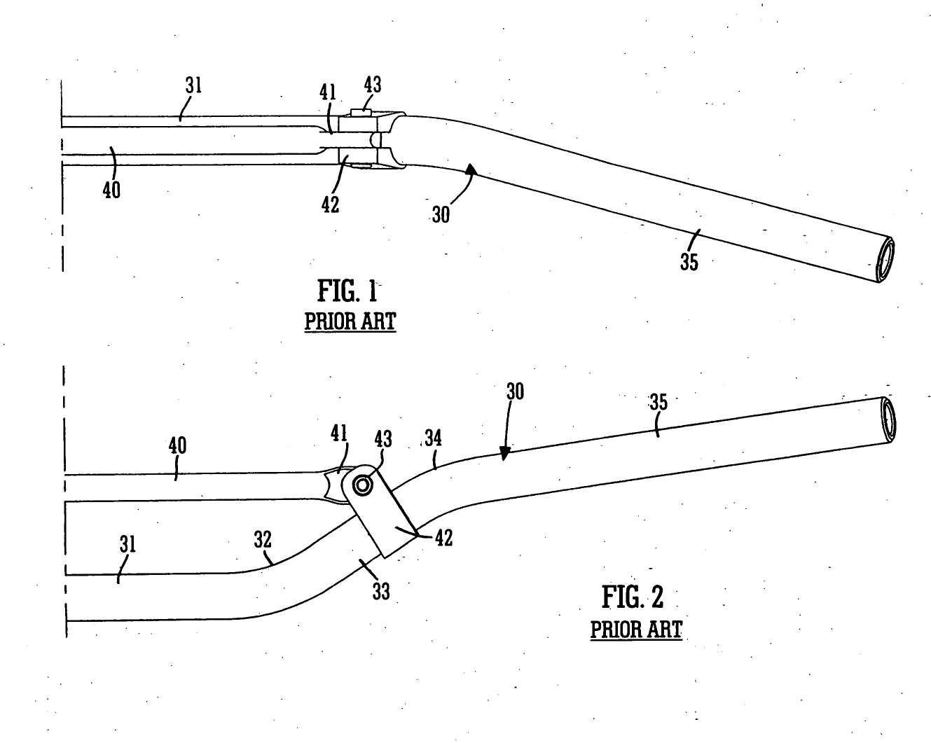

FIGS. 1 and 2 show the configuration of a conventional 7/8 inch (22.23 mm) diameter motorcycle handlebar 30. The other half is, of course, symmetrical. A central section 31 leads at each end, via a proximal bend 32 to an intermediate or bent section 33. This leads, via a respective distal bend 34 to a respective end section 35, which is also bent out of the plane of the central and intermediate sections 31, 33 as is apparent from FIG. 1. The handlebar 30 is typically of tubular form, i.e. hollow, and of an aluminium alloy, although steel handlebars are also known. A cross brace 40, which is a simple rod of the same metal or alloy formed with flattened straps or ears 41 at each end is fitted between the intermediate or bent sections 33 by means of respective cross brace clamps 42. Each cross brace clamp 42 surrounds the bar 30 and has opposed end margins which are secured. In the illustrated version they are secured by a bolt 43 which also extends through the end 41 of the cross brace 40. In other known versions two bolts may be employed, one to secure the ends of the clamp 42 and another to attach the cross brace 40.

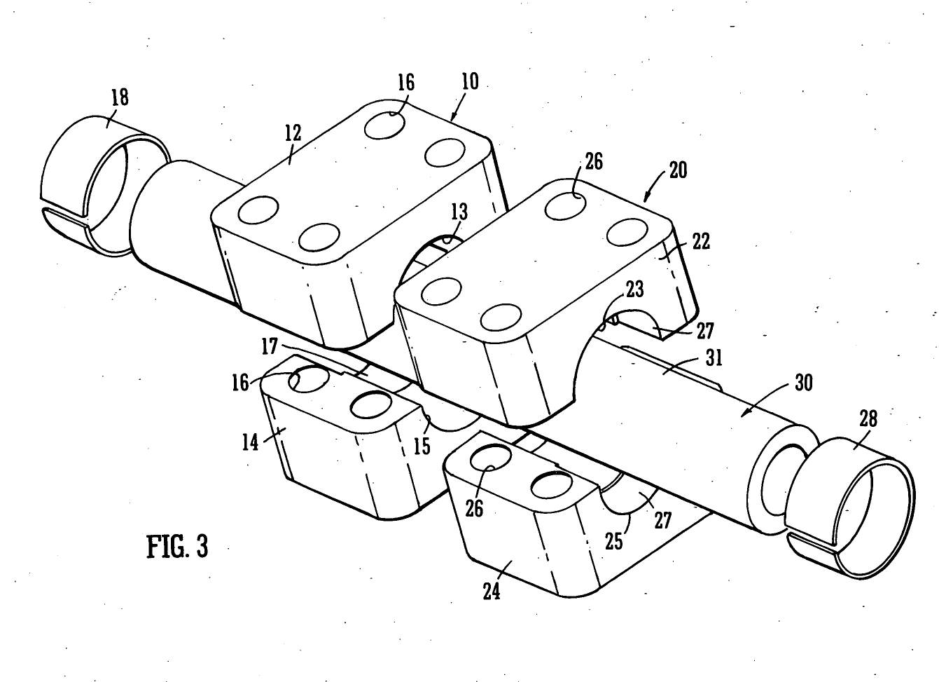

In a first practical embodiment, in accordance with the invention, as shown in FIG. 3, a pair of clamps (also referred to as mountings) 10, 20 are fitted symmetrically and at a short spacing apart either side of the centre of the motorcycle handlebar 30. Each clamp 10, 20 consists of an upper and a lower clamp element 12, 14 and 22, 24 respectively having opposing part cylindrical clamping surfaces 13, 15 and 23, 25 respectively. There are four apertures 16, 26 through each element, those in the upper elements 12, 22 being aligned with those in the lower elements 14, 24 so that the respective upper elements 12, 22 can, in use, be secured to their respective lower elements 14, 24, by means of bolts therethrough (not shown), thereby clamping the central section 31 of the handlebar 30 immovably therebetween.

The clamp elements 12, 14, 22, 24 are preferably formed of aluminium alloy to match the material of the handlebar 30. However, other metals such as steel would be possible, as already mentioned in respect of the bar 30. The clamp elements 12, 14, 22, 24 may be about 4 to 5 cm in length, ie longitudinally of the bar 30.

Referring firstly to the clamp 10, a recess 17 which is about 1 mm deep and about 1.5 cm long is cut into the respective clamping surfaces 13, 15 adjacent one end of the clamp, which in use is the end from which the handlebar 30 extends unsupported to its hand grip region, which is not shown in FIG. 3 but is the same as the end section 35 of FIGS. 1 and 2. A protective component in the form of a nylon bush 18, which is of cylindrical form, but split from end to end, is received within this recess 17. It is of corresponding size to the recess, being about 1 mm thick and about 1.5 cm long.

The other clamp 20 has a corresponding recess 27 of the same size adjacent the outer edge of its clamping surfaces 23, 25, ie the edge remote from the first clamp 10, from which the handlebar 30 extends towards its other hand grip region (not shown). Again a corresponding nylon bush 28 fits into this recess.

The bushes 18, 28 are sufficiently flexible to be opened at their slits and engaged around the handlebar, and the clamps 10, 20 are then placed thereover, accurately positioned and then secured around the bar 30.

The presence of the nylon bushes 18, 28 will greatly increase the fatigue life of the bar 30 as previously explained. However, there is sufficient direct metal to metal contact between the remainder of the clamping surfaces 13, 15 and 23, 25 and the bar 30 to ensure that the bar 30 is firmly and non-rotatably secured in the mountings 10, 20.

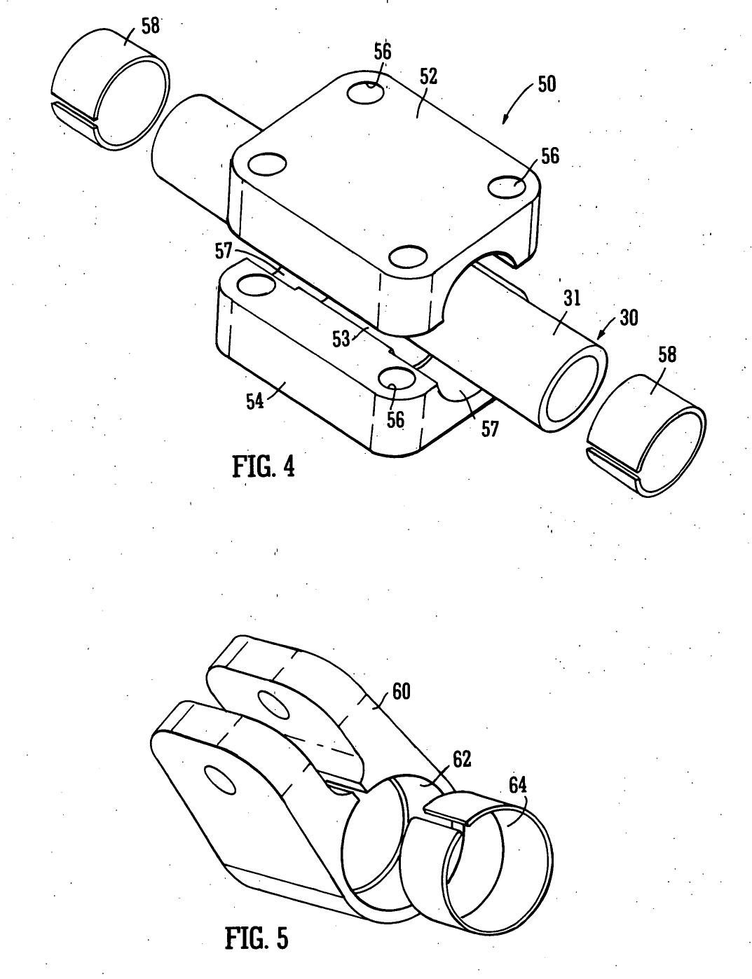

In a second practical embodiment, as illustrated in FIG. 4, the invention is applied to a single central clamp (also referred to as a mounting) 50 comprising upper and lower clamp elements 52, 54, which would be secured around the central section 31 of the bar by bolts through apertures 56. In this case respective nylon bushes 58 are mounted in recesses 57 at each end of the clamp surface 53, but with a section of direct metal to metal contact between the clamp elements 52, 54 and the bar 30 between the respective bushes 58.

The same level of fatigue life increase can be achieved as with the spaced apart pair of clamps in the first embodiment.

In a third practical embodiment, as illustrated in FIG. 5, the invention is applied to a cross brace clamp 60, which is similar in other respects to the conventional cross brace clamp 42 shown in FIGS. 1 and 2 and in use would be positioned on a handlebar 30 and used to secure a cross brace 40 in an identical manner. At its outer end, adjacent the distal bend 35 of the bar 30, each cross brace clamp 60 is formed with an internal recess 62 into which a nylon bush 64 is seated. As before the bush 64 is split for ease of fitting over the bar. The bush 64 only extends part of the length of the clamp 60, and a similar increase in the fatigue life of the bar as with the previous centre mounting arrangements is achievable.

The foregoing is, of course, illustrative and not limitative of the scope of the invention. Many variations are possible in other embodiments, namely in the material and configuration of the protective components and their dimensions and in the precise configuration, material, and constitution of the clamps, including the number of apertures and fastening bolts and their positioning. It will be apparent to any skilled person that the principle of the invention can be applied in respect of any known or yet to be devised construction of handlebar clamp, whether central clamp or cross brace clamp.

1. A handlebar clamp comprising mounting means adapted to embrace and clamp a handlebar, said mounting means having first and second ends longitudinally of the bar, a clamping surface facing the bar and a recess formed in the clamping surface and extending from said first end part way towards said second end, and a protective component, of a material softer than that of the clamp and the handlebar, which is seated in that recess so as, in use, to be interposed between the mounting means and the handlebar for only a part of the length of the clamping surface.

2. A handlebar clamp as set forth in claim 1 wherein the protective component is in the form of a substantially cylindrical insert which is split from end to end.

3. A handlebar clamp as set forth in claim 1 wherein the protective component is formed of a plastics material.

4. A handlebar clamp as set forth in claim 3 wherein the protective component is formed of polymeric material.

5. A handlebar clamp as set forth in claim 1 wherein the protective component has a length of at least 5 mm.

6. A handlebar clamp as set forth in claim 1 wherein the protective component has a thickness of at least 0.5 mm.

7. A handlebar clamp comprising mounting means adapted to embrace and clamp a handlebar, said mounting means having first and second ends longitudinally of the bar, a clamping surface facing the bar, a first recess formed in the clamping surface and extending from said first end part way towards said second end, and a second recess formed in the clamping surface and extending from said second end part way towards said first end, a first protective component, of a material softer than that of the clamp and the handlebar, which is seated in said first recess and a second protective component, also of a material softer than that of the clamp and the handlebar, which is seated in said second recess so that, in use, the protective components are interposed between the mounting means and the handlebar for only a part of the length of the clamp with a central region of the clamping surface therebetween.

8. A handlebar clamp as set forth in claim 7 wherein each protective component is in the form of a substantially cylindrical insert which is split from end to end.

9. A handlebar clamp as set forth in claim 7 wherein each protective component is formed of a plastics material.

10. A handlebar clamp as set forth in claim 9 wherein each protective component is formed of polymeric material.

11. A handlebar clamp as set forth in claim 7 wherein each protective component has a length of at least 5 mm.

12. A handlebar clamp as set forth in claim 7 wherein each protective component has a thickness of at least 0.5 mm.

13. A handlebar clamping arrangement comprising a metal handlebar, metal mounting means embracing and clamping the handlebar and having first and second ends longitudinally of the bar, a clamping surface facing and contacting the bar and a recess formed in the clamping surface and extending from said first end part way towards said second end, and a protective component, of a material softer than that of the handlebar or the mounting means, which is seated in said recess and thereby interposed between the mounting means and the handlebar for a distance extending from the first end of the mounting means only part way along the mounting means towards the second end thereof.
